(19) United States
(12) Patent Application Publication
(10) Pub. No.: US 2012/0000486 A1
(43) Pub. Date: Jan. 5, 2012

(54) EMITTER WIRE CLEANING DEVICE WITH WEAR-TOLERANT PROFILE

(75) Inventors: Daniel Braunstein, Arlington, MA (US); Peter Bates, Framingham, MA (US); Guilian Gao, San Jose, CA (US); Ron Goldman, Oakland, CA (US); Elizabeth Kneen, Somerville, MA (US); Matt Schwiebert, Cupertino, CA (US); Zach Traina, Hingham, MA (US)

(73) Assignee: TESSERA, INC., San Jose, CA (US)

(21) Appl. No.: 12/828,079

(22) Filed: Jun. 30, 2010

(51) Int. Cl. B08B 1/00

(52) U.S. Cl. 134/6; 15/4

(57) ABSTRACT

An apparatus for cleaning an emitter electrode in electrohydrodynamic fluid accelerator and precipitator devices via movement of a cleaning device including complementary contoured cleaning surfaces positioned to frictionally engage and elastically deform the emitter electrode. The opposing cleaning surfaces laterally distort an otherwise linear longitudinal extent of the electrode under tension. The opposing cleaning surfaces are subject to wear, but maintain frictional engagement despite wear depths that exceed a radius of the electrode due at least in part to the at least partially complementary surface contours engaging the electrode under tension. The cleaning device causes respective cleaning surfaces to travel along a longitudinal extent of the emitter electrode to remove detrimental material and optionally to condition the electrode to at least partially mitigate ozone, erosion, corrosion, oxidation, or dendrite formation on the electrode.

### BACKGROUND

1. Field of the Invention

This application relates generally to cleaning of electrodes in electrohydrodynamic or electrostatic devices such as electrohydrodynamic fluid accelerators and electrostatic precipitators.

Many electronic devices and mechanically operated devices require air flow to help cool certain operating systems by convection. Cooling helps prevent device overheating and improves long term reliability. It is known to provide cooling air flow with the use of fans or other similar moving mechanical devices; however, such devices generally have limited operating lifetimes, produce noise or vibration, consume power or suffer from other design problems.

The use of an ion flow air mover device, such as an electrohydrodynamic (EHD) device or electro-fluid dynamic (EFD) device, may result in improved cooling efficiency, reduced vibrations, power consumption, electronic device temperatures, and noise generation. This may reduce overall device lifetime costs, device size or volume, and may improve electronic device performance or user experience.

In many EHD or EFA devices and other similar devices, detrimental material such as silica dendrites, surface contaminants, particulates or other debris may accumulate or form on electrode surfaces and may decrease the performance, efficiency and lifetime of such devices. In particular, siloxane vapor breaks down in a plasma or corona environment and forms solid deposits of silica on the electrode, e.g., emitter or collector electrode. Other detrimental materials may also build up on various electrode surfaces. Buildup of such detrimental materials can decrease efficiency, performance and reliability, cause sparking or reduce spark-over voltage and contribute to device failure. Periodic removal of these deposits is needed to restore performance and reliability.

Accordingly, improvements are sought in cleaning and conditioning electrode surfaces.

2. Description of the Related Art

Devices built using the principle of the ionic movement of a fluid are variously referred to in the literature as ionic wind machines, electric wind machines, corona wind pumps, electro-fluid-dynamics (EFD) devices, electrohydrodynamic (EHD) thrusters and EHD gas pumps. Some aspects of the technology have also been exploited in devices referred to as electrostatic air cleaners or electrostatic precipitators.

In general, EHD technology uses ion flow principles to move fluids (e.g., air molecules). Basic principles of EHD fluid flow are reasonably well understood by persons of skill in the art. Accordingly, a brief illustration of ion flow using corona discharge principles in a simple two electrode system sets the stage for the more detailed description that follows.

With reference to the illustration in FIG. 1, EHD principles include applying a high intensity electric field between a first electrode 10 (often termed the “corona electrode,” the “corona discharge electrode,” the “emitter electrode” or just the “emitter”) and a second electrode 12. Fluid molecules, such as surrounding air molecules, near the emitter discharge region 11 become ionized and form a stream 14 of ions 16 that accelerate toward second electrode 12, colliding with neutral fluid molecules 22. During these collisions, momentum is imparted from the stream 14 of ions 16 to the neutral fluid molecules 22, inducing a corresponding movement of fluid molecules 22 in a desired fluid flow direction, denoted by arrow 13, toward second electrode 12. Second electrode 12 may be variously referred to as the “accelerating,” “attracting,” “target” or “collector” electrode. While stream 14 of ions 16 is attracted to, and generally neutralized by, second electrode 12, neutral fluid molecules 22 continue past second electrode 12 at a certain velocity. The movement of fluid produced by EHD principles has been variously referred to as “electric,” “corona” or “ionic” wind and has been defined as the movement of gas induced by the movement of ions from the vicinity of a high voltage discharge electrode 10.

### SUMMARY

It has been discovered that an electrohydrodynamic (“EHD”) emitter wire electrode may be cleaned of silica deposits using a cleaning device having a contoured or radiused wear-tolerant profile constructed to elastically deform the emitter electrode as the cleaning device is moved along the wire electrode. By placing the emitter wire electrode into an elastic serpentine bend, detrimental material, such as silica accumulated thereon during EHD device operation, can be effectively broken up and wiped off.

It has also been discovered that such contoured cleaning device profiles can maintain substantial contact between the wiper and emitter wire electrode over extended cleaning cycles providing effective removal of accumulated deposits from the EHD emitter wire electrode even after wearing of the cleaning device.

In some implementations, inducing an elastic electrode bend or even multiple serpentine bends can break up and remove accumulated deposits and thereby restore electrode performance and reliability.

In some implementations, the emitter electrode is lightly clamped between two opposing cleaning device pads defining complementary surfaces shaped to induce a controlled bend in the wire. The radius of the bend is selected such that the ratio of the emitter wire radius to the bend radius does not exceed the yield strain of the emitter wire material to avoid plastic, i.e. permanent, deformation. Such elastic deformation and controlled bending stresses break up brittle silica deposits on the emitter wire. The serpentine bend also ensures consistent contact between the cleaning device pads and the emitter wire as the pads wear.

In some implementations, a cleaning device includes opposing surfaces to frictionally engage an electrode susceptible to accumulation of detrimental material during operation. The opposing surfaces exhibit at least partially complementary surface contours that, when engaged, laterally distort an otherwise linear longitudinal extent of the electrode under tension. The opposing surfaces are subject to wear but maintain frictional engagement despite wear depths that exceed a radius of the electrode due at least in part to the at least partially complementary surface contours engaging the electrode under tension.

In some implementations, the electrode, when energized, contributes to flow of ion current in one of an electrohydrodynamic fluid accelerator and an electrostatic precipitator.

In some implementations, the electrode is an emitter wire having a radius, and the surface contours are selected such that a ratio of the electrode radius to a minimum contour radius does not exceed the yield strain of the electrode material.

In some implementations, the surface contours are selected to elastically deform the emitter electrode in a first direction during longitudinal travel and the cleaning device is laterally moveable to elastically deform the emitter electrode in a second direction.

In some implementations, the cleaning device is angularly positioned such that the electrode travels at least partially laterally across a respective cleaning device surface during movement of the cleaning device along a longitudinal extent of the electrode.

In some implementations, the EHD device is part of a thermal management assembly for use in convective cooling of one or more devices within an enclosure. The thermal management assembly defines a flow path for conveyance of air between portions of the enclosure over heat transfer surfaces positioned along the flow path to dissipate heat generated by the one or more devices. The thermal management assembly includes an electrohydrodynamic (EHD) fluid accelerator including collector and emitter electrodes energizable to motivate fluid flow along the flow path, wherein at least one of the electrodes is susceptible to accumulation of detrimental material during operation thereof. A cleaning device includes opposing surfaces defining at least partially complementary surface contours that, when engaged with the at least one electrode, elastically deform an otherwise linear longitudinal extent of the at least one electrode under tension.

In some implementations, the cleaning device is moveable in response to detection of one of a low thermal duty cycle, power-on cycle and a power-off cycle of the one or more devices, sparking, voltage levels, current levels, acoustic levels, and detection of performance degradation.

In some implementations, the one or more devices includes one of a computing device, projector, copy machine, fax machine, printer, radio, audio or video recording device, audio or video playback device, communications device, charging device, power inverter, light source, medical device, home appliance, power tool, toy, game console, television, and video display device.

In some applications, a method of removing detrimental material from an electrode includes positioning a cleaning device in frictional engagement with the electrode and transiting one of the cleaning device and the electrode relative to the other of the cleaning device and the electrode to thereby remove detrimental material accumulated on the electrode. The cleaning device includes opposing surfaces defining at least partially complementary surface contours that, when engaged with the electrode, elastically deform an otherwise linear longitudinal extent of the electrode under tension. The method further includes elastically deforming the electrode to break up detrimental material accumulated on the electrode.

In some applications, the opposing surfaces are subject to wear from repeated transiting cycles, the method further comprising maintaining the frictional engagement despite wear depths that exceed a radius of the electrode due at least in part to the at least partially complementary surface contours engaging the electrode under tension.

In some applications, the method further includes depositing a conditioning material on the electrode in situ via transiting of the one of the cleaning device and the electrode. In some cases, the cleaning device is wearable to form a sacrificial coating selected to mitigate electrode oxidation or to reduce ozone.

In some applications, the method includes positioning the cleaning device such that the electrode travels at least partially laterally across a respective cleaning device surface.

In some applications, the cleaning device is further moveable laterally relative to a longitudinal extent of the electrode to provide multi-axial deformation of the electrode. In some cases, the cleaning pads are skewed out of plane relative to the electrode.

### BRIEF DESCRIPTION OF THE DRAWINGS

The present invention may be better understood, and its numerous objects, features, and advantages made apparent to those skilled in the art by referencing the accompanying drawings.

FIG. 1 is a depiction of certain basic principles of electrohydrodynamic (EHD) fluid flow.

FIG. 2 depicts a side view of a cleaning device having opposing contoured cleaning pads with leading and trailing wearable conditioning materials, in accordance with various implementations.

FIG. 3 depicts a side view of a cleaning device having opposing contoured cleaning pads with central wearable conditioning materials, in accordance with various implementations.

FIG. 4 illustrates a side view of a cleaning device including serpentine contoured cleaning pads for elastically deforming and cleaning an elongated emitter electrode, in accordance with various implementations.

FIGS. 5A-5B illustrate side and cross-sectional views of a cleaning device defining contoured cleaning pads for elastically deforming an elongated emitter electrode, in accordance with various implementations.

FIG. 6 illustrates a top view of a cleaning device laterally deforming an electrode.

FIG. 7 depicts a translatable cleaning device slidably fitted on opposed collector electrodes and positioning respective cleaning pads in contact with the collector electrodes and the emitter electrode for tandem cleaning of the electrodes.

FIG. 8 depicts an electronic system employing an implementation of EHD device subject to cleaning of accumulated material as described herein.

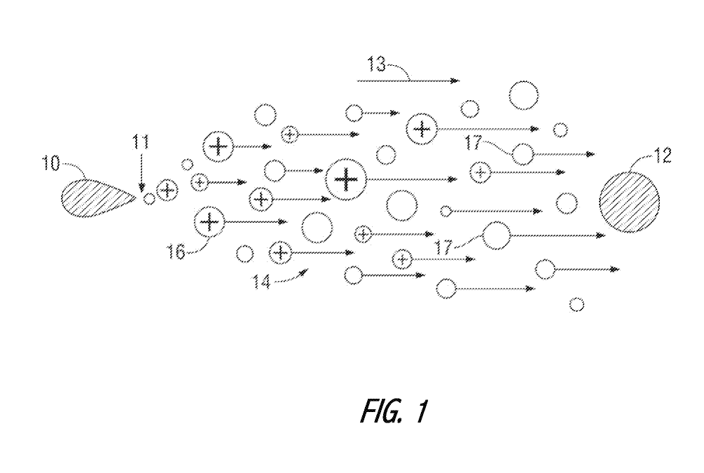

The use of the same reference symbols in different drawings indicates similar or identical items.

### DESCRIPTION OF THE PREFERRED EMBODIMENT(S)

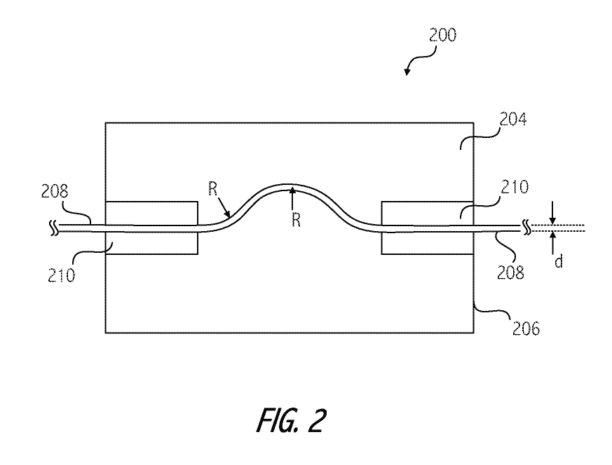

With reference to FIG. 2, a cleaning device 200 includes complementary contoured cleaning pads 204 and 206 positioned to frictionally engage at least a portion of an elongated emitter electrode 208. In some implementations, cleaning device 200 is moveable to cause cleaning pads 204 and 206 to travel along a longitudinal extent of emitter electrode 208 to thereby remove detrimental material such as silica dendrites, surface contaminants, particulate or other debris from the respective electrode surfaces. Cleaning pads 204 and 206 are contoured to elastically deform electrode 208 in a bend to remove dendrites or other detrimental material from electrode 208 or to otherwise clean or condition the electrode.

The radius of the bend is selected to avoid plastic deformation of the electrode 208. For example, the electrode diameter and bend radius are selected such that a ratio of the electrode radius to a bend radius does not exceed the yield strain of the electrode material. The complementary surfaces of cleaning pads 204 and 206 can include multiple undulations inducing controlled bending stress in electrode 208 to break up brittle silica deposits on the electrode. Deflection of electrode 208 also helps maintain contact between electrode 208 and the cleaning pads 204 and 206 as the pads wear.

Emitter electrode 208 may be energizable to generate ions and may be positioned relative to a collector electrode(s) to motivate fluid flow along a fluid flow path. Thus, emitter electrode 208 and a collector electrode(s) may at least partially define an EHD fluid accelerator. Any number of additional electrodes may be positioned upstream and downstream of the EHD fluid accelerator along the fluid flow path. For example, in some implementations, a collector electrode can be disposed upstream of the EHD fluid accelerator along the fluid flow path and can operate as an electrostatic precipitator. Additional cleaning surfaces can be provided to frictionally engage and travel over surfaces of the collector electrode or additional electrodes independent of or in tandem with travel of cleaning device 200 along the longitudinal extent of emitter electrode 208.

Alternatively, in some implementations, emitter electrode 208 may be moveable relative to cleaning device 200. For example, cleaning device 200 may be trained in a loop about drive pulleys or may be wound about take-up and supply spools, or may be otherwise transited across cleaning pads 204 and 206 of cleaning device 200.

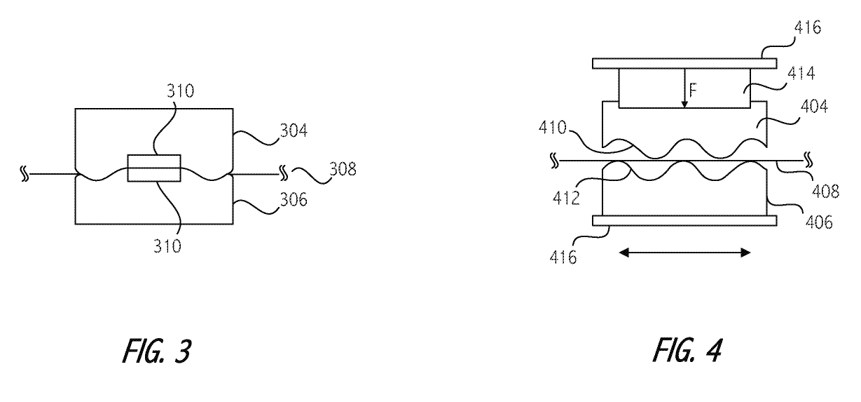

With reference to FIG. 3, cleaning pads 304 and 306 can include conditioning material inserts 310 for surface conditioning of electrode 308. Conditioning material inserts 310 may be centrally positioned on cleaning pads 304 and 306. In some cases, cleaning is performed primarily at the corresponding leading edge cleaning surfaces of cleaning pads 304/306 and conditioning is performed as the electrode 308 passes over conditioning material inserts 310.

Conditioning material inserts 310, may be integral with and replaceable with cleaning pads 304/306, or may be removable and replaceable as needed. Inserts 310 may be retained by adhesion, fasteners, interference fit or other suitable means. Conditioning material inserts 310 can include similar or different conditioning material compositions. For example, one conditioning material composition can provide an electrode shielding composition to protect against oxidation, and another conditioning material composition can include an ozone reducer. Thus, both electrode cleaning and conditioning can be performed by movement of cleaning pads 304/306 along electrode 308.

In some implementations, the cleaning pads can include multiple cleaning or conditioning regions or surfaces. In some cases, the cleaning pads each include at least a first region for removing dendrites from the electrode through bending and frictional cleaning, and at least a second region for depositing a conditioning material coating on the electrode. In some cases, cleaning and conditioning can be simultaneously performed by movement of the cleaning device and even by the same cleaning device surfaces. The cleaning pads may include any combination of surface profiles, including flat, curved, grooved, undulating, and the like to provide a desired degree of frictional contact and/or electrode deformation during cleaning. Various electrodes may be formed as a wire, bar, array, block, strip, or other form and the cleaning device can be constructed to clean any desired portion of surfaces of the electrodes.

With continued reference to FIG. 3, in some implementations, cleaning pads 304 and 306 are independently replaceable or are replaceable as a set.

Cleaning pads 304 and 306 may be periodically replaced as needed. For example, cleaning pads 304 and 306 may be initially spaced a distance apart and may eventually contact due to wearing of the cleaning pads through extended cleaning cycles. Thus, contact of cleaning pads 304/306 may be used, for example, to indicate an end of pad life. In some cases, operation of the cleaning device 300 may result in the removal of some of the cleaning pad material resulting in a groove forming or deepening in the cleaning pad(s).

While cleaning pads 304 and 306 are depicted as mating opposed counterparts on opposite surfaces of electrode 308, it will be understood that the invention is not limited to two-part cleaning pads for use with wire electrodes as shown in the figure, but may include single cleaning pads or other cleaning devices such as shuttles, beads, brushes, or multiple cleaning heads and surfaces for use with electrodes of other shapes. Cleaning device 300 may be used to remove detrimental material from respective electrode surfaces with single or multiple longitudinal passes or other movement, including lateral movement relative to a longitudinal extent of an electrode.

With reference to FIG. 4, in some implementations, the respective opposed cleaning pads 404 and 406 are urged against one another and/or against the emitter electrode 408 by an applied force “F.” Applied force “F” can be provided by a compressed foam block 414, spring or other mechanism disposed between at least one of the cleaning pads 404/406 and a corresponding support structure 416. Cleaning pads 404 and foam block 414 are arranged to provide pressure between cleaning pad 404 and electrode 408 sufficient to frictionally clean electrode 408, which can also be deflected or deformed thereby for cleaning and conditioning. In some cases, applied force “F” may be generated by an interference or compression fit between a cleaning device and an electrode or via a clamping device acting on the cleaning device.

Cleaning pads 404 can be constructed and arranged such that applied force “F” does not plastically deform the electrode, i.e., such that the force exerted on the electrode when the blocks are fully compressed would not exceed an elastic deformation limit leading to plastic deformation of the electrode. Similarly, applied force “F” may be controlled to avoid plastic deformation of the electrode.

In a particular case, an elongated emitter electrode wire 408 is positioned in spaced relation, e.g., 1-5 mm, to a collector electrode and energizable to establish a corona discharge therebetween. The emitter electrode wire 408 is placed in tension, e.g., 10-30 g, and is cleaned using contoured carbon cleaning pads 404 and 406, with a 40-80 g preload between the cleaning pads 404 and 406 and emitter electrode 408. The carbon bearing cleaning pads 404/406 are transited along the emitter electrode 408 at about 13 mm/s in both an initial pass and a return pass. The carbon present on the cleaning pads 404/406 is sufficiently hard to effectively remove detrimental material from electrode 408 and sufficiently soft to wear and deposit a carbon coating on electrode 408. Carbon is but one example of a material that may be used to at least partially form cleaning pads 404 and 406. Other materials may be used, e.g., to provide ozone reducing coatings, sacrificial coatings, electrode surface refinishing, electrode lubrication, or other useful conditioning of electrodes.

In various elongated electrode implementations, varying degrees of electrode tension, clamping force “F” and cleaning speeds may be employed. For example, cleaning pads having a softer surface, e.g., felt or bristled brushes, may employ a higher electrode clamping force “F” preload, e.g., 350 g. An applied force “F” may be provided between a cleaning pad and an electrode or between cleaning surface counterparts by springs, compressible foam, magnetic repulsion, fringing fields, solenoids, electrical repulsion, or any other means of providing a desired force.

Performance of an emitter electrode can deteriorate due to dendrite growth in a relatively short period of operation, e.g., 30-120 minutes. Accordingly, regular cleaning may be advantageously initiated as a function of detection of dendrite growth, according to a periodic schedule, or in response to various events, e.g., power cycles, electrode arcing or performance characteristics, e.g., acoustic, voltage, or current levels.

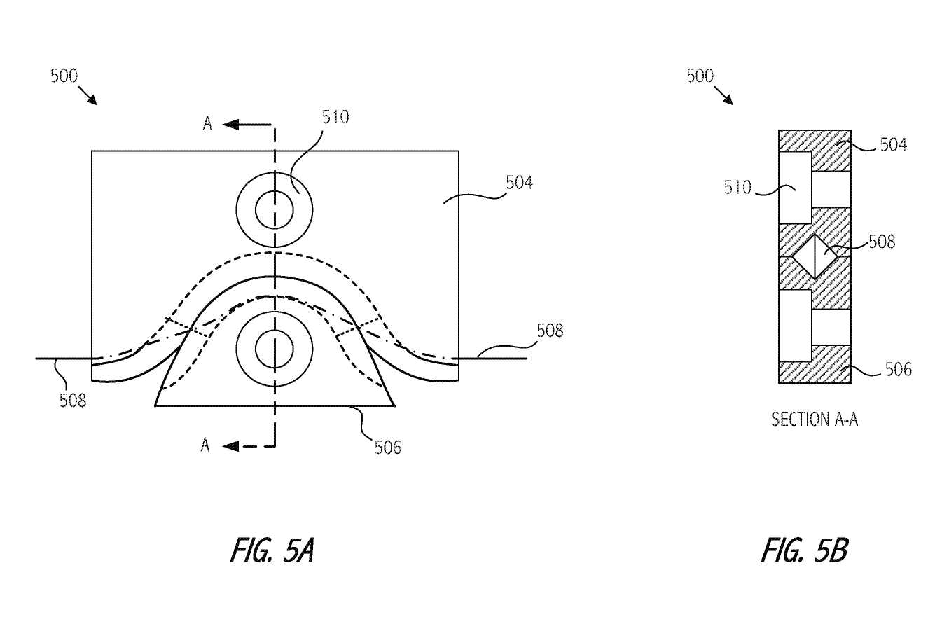

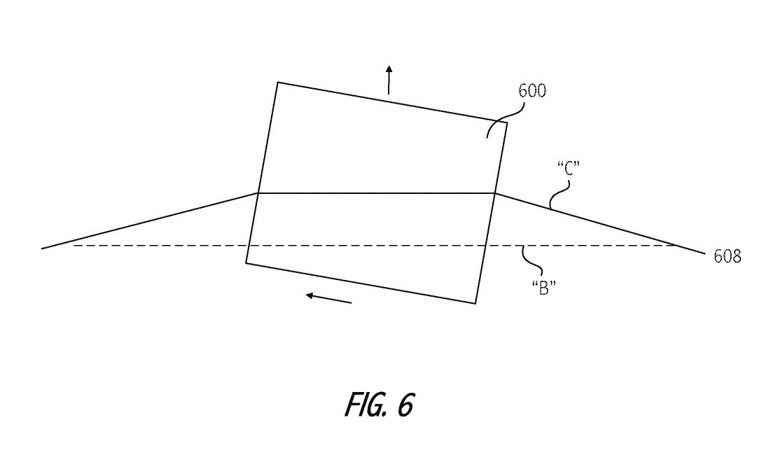

With reference to FIGS. 5A-5B, a cleaning device 500 is constructed and arranged to elastically deform the electrode 508 during cleaning via a radiused contour of a cleaning surface, electrode guide or other suitable electrode contact feature. In some implementations, electrode 508 is clamped between two cleaning pads 504 and 506, each of which define complementary radiused surfaces for deflecting electrode 508 into a controlled bend.

With reference to FIG. 5A and the cross-sectional view of FIG. 5B, a mechanical cleaning device 500 includes first and second opposed cleaning pads 504 and 506 defining cleaning surfaces for frictionally contacting electrode 508. Cleaning pads 504 and 506 together define a contoured electrode path providing for elastic deformation of electrode 508 and frictional cleaning contact on obverse electrode surfaces. As the cleaning pads 504 and 506 are transited past electrode 508, electrode guide 508 is depicted in cross-sectional view as defining a channel sized to receive an electrode therein.

In some instances, elastic deformation of the electrode increases cleaning or conditioning efficacy or control. For example, a degree of deformation of the electrode or a degree of friction at certain points of contact may be controlled to vary cleaning and conditioning parameters, e.g. tension in the electrode or pressure or spacing between cleaning pads 504 and 506 may be varied. For example, cleaning pads 504 and 506 may initially be spaced a distance apart and may gradually move closer together and eventually contact one another following wear from extended cleaning cycles.

Cleaning pads 504 and 506 are depicted as defining apertures 510 for receiving fasteners to attach pads 504 and 506 to a movable cleaning device. For example, pads 504 and 506 may be attached as a fixture to a movable carriage for transiting cleaning pads 504 and 506 relative to electrode 508.

With reference to FIG. 5B, cleaning pads 504 and 506 are shown in contact along edge portions thereof. In some implementations, cleaning pads 504 and 506 may be brought into contact with the electrode only during cleaning operations. In some cases, contact between cleaning pads 504 and 506 may be used to indicate pad wear or an end of life state.

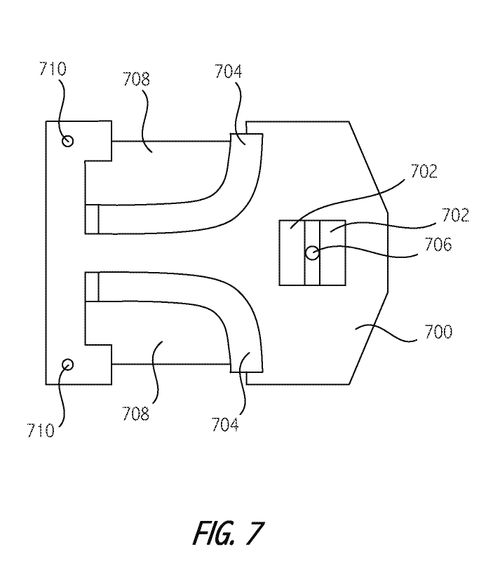

With reference to FIG. 6, in some implementations, orthogonal or lateral travel of cleaning device 600 serves to laterally deform electrode 608 as cleaning device 600 travels a longitudinal extent of electrode 608 to further break up deposits of detrimental materials accumulated thereon. This lateral deformation can be in addition to other electrode deformation introduced in other directions, e.g., via cleaning pad contours as earlier described. In some cases, an elongated electrode 608 may be bent or otherwise deformed in a first direction while being pulled or deformed in a second direction. For example, electrode 608 may be displaced from a first operational position “B” to a second laterally displaced or laterally deformed position “C” during cleaning operations.

Cleaning device 600 can be inclined front to back and/or side to side to achieve a desired lateral displacement and elastic deformation of electrode 608. Additionally, cleaning device 600 may be moveable relative to electrode 608 along any desired path to induce lateral displacement and elastic deformation of electrode 608. For example, cleaning device 600 may travel an arcuate or otherwise divergent path relative to elongated emitter electrode 608 to induce lateral deformation of electrode 608. Alternatively or additionally, cleaning device 600 may be rotated or tilted about an axis orthogonal to the longitudinal extent of the emitter electrode such that electrode 608 is elastically deformed both by the profile of cleaning pads, such as earlier described pads 304/306, and by an off-axis on skewed orientation of the cleaning pads relative to emitter electrode 608. Thus, electrode 608 may be subjected to bending or deformation about two or more orthogonal axes in a variety of methods and cleaning device configurations.

Such angular positioning of cleaning device 600 combined with lateral tensioning or lateral movement of electrode 608 by cleaning device 600 can cause electrode 608 to travel at least partially laterally across the face of cleaning device 600. Introduction of a lateral component to movement of electrode 608 across cleaning device 600 can provide more even wear of cleaning device surfaces over time and reduce formation of grooves typical of aligned longitudinal travel. In various implementations, cleaning device 600 can be oriented at different angles than those illustrated, e.g., vertically, and can be angularly positionable or moveable about any number of axes to contact or deform the electrode.

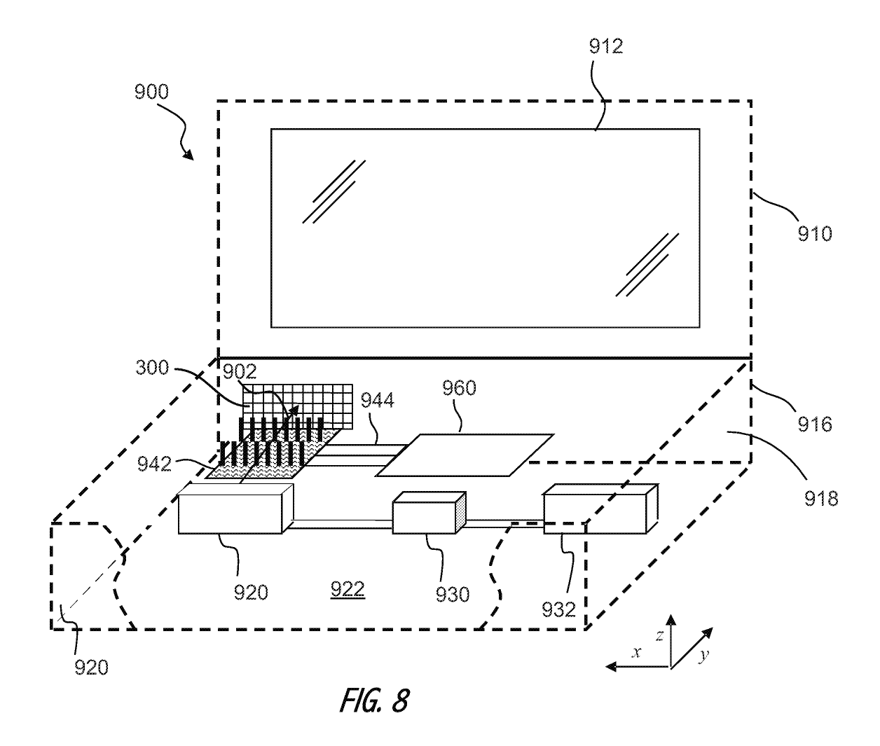

With reference to FIG. 7, cleaning device 700 includes vertically oriented cleaning pads 702 on opposite sides of emitter electrode 706. Additional cleaning pads 704 engage collector electrodes 708. A drive cable 710 or other suitable drive structure is positioned behind the collector electrodes 708 away from emitter electrode 706. Such positioning of drive belt or drive cable 710 away from electrode 706 can reduce charging and sparking to drive cable 710 from electric fields around electrode 706 and can also help avoid interference with electric fields around the electrode 706.

In some implementations, collector electrodes 708 serve as a guide for movement and alignment of cleaning device 700. In some cases, cleaning device 700 can be slidingly retained on electrode 708. For example, cleaning device 700 can extend between electrodes 708 with cleaning surfaces 704 retained adjacent respective surfaces of electrodes 708 by a sliding fit between complementary electrode, pad and cleaning device contours.

With continued reference to FIG. 7, first respective cleaning pads 702 may travel along a longitudinal extent of emitter electrode 706, and second respective cleaning pads 704 travel in tandem over a major dimension of a surface of collector electrodes 708 or other electrode(s). For example, an EHD or EFA device can also include grounding electrodes, repelling electrodes, backflow electrodes or other electrodes.

In the illustrated implementation, cleaning device 700 includes multiple cleaning surface pairs 702 and 704 positioned to clean respective surfaces of electrodes 706 and 708. Additionally, cleaning device 700 may be fitted with additional cleaning surfaces to be transited past any number of electrodes, filters, or other system features prone to detrimental material accumulation and in need of mechanical cleaning or other surface conditioning.

Cleaning device 700 can be driven or translated via a drive cable 710 trained about a drive pulley and idler pulley. Other types of drive mechanisms may be used to move cleaning device 700 to thereby clean and/or condition an electrode. Cleaning device 700 may be movable in single passes such that cleaning device 700 moves between alternate ends of electrodes 706 and 708 in each cycle. Alternatively, cleaning device 700 may reciprocate or move bidirectionally in a single cycle or it in may perform any combination of movements at various speeds in a given cycle.

In some implementations, a wiper, e.g. brush, or other secondary cleaning device may be positioned to contact cleaning device leading edges or surfaces adjacent cleaning pads 702 and 704 where detrimental material dislodged from electrodes 706 or 708 may accumulate on cleaning device 700. Thus, secondary detrimental material accumulation may be removed from cleaning device 700 including cleaning pads 702 and 704 by a brush or other suitable secondary cleaning device. Detrimental material dislodged by the brush can be accumulated in a receptacle area positioned adjacent a stowed position where the cleaning device 700 is parked between cleaning cycles. Accumulated particulate can be periodically discarded or may be otherwise exhausted from the system.

Cleaning pads of various cleaning device implementations may be formed of a wearable material including a conditioning material composed to reduce adhesion, reduce ozone, or mitigate adverse affects of an ion bombardment or plasma environment, such as oxidation. For example, silver oxide may serve both as a sacrificial coating and to reduce ozone.

In a particular implementation, the cleaning pads are formed of a substantially solid, wearable graphite conditioning material. In some implementations, the wearable conditioning material is substantially softer than the electrode plating to avoid electrode damage during cleaning/conditioning. In some cases, conditioning material compositions can include carbon, silver, platinum, magnesium, manganese, palladium, nickel, or oxides or alloys of the same. In some cases, the conditioning material composition includes carbon, organometallic materials that decompose under plasma conditions or ion bombardment, and combinations thereof.

In some implementations, the conditioning material may be selected to have an ozone reduction function, e.g., to mitigate ozone generated by the EHD device. For example, a material that includes silver (Ag) may be used to reduce ozone production and may also be used to prevent silica growth. In some implementations, the conditioning material can provide a sacrificial layer or protective coating. Such a coating need not be continuous over the entirety of the operating surface of an electrode. In some cases, the coating may provide low adhesion or a “non stick” surface, or it may have a surface property that repels silica, which is a common material in dendrite formation. As an illustrative example, the conditioning material may include carbon such as graphite, and may have low adhesion to dendrite formation and other detrimental material, and may improve the ease of mechanically removing such detrimental material.

In some cases, the conditioning material may serve as a sacrificial layer that is oxidized or eroded by the plasma environment or by ion bombardment. Replenishment of this sacrificial layer via movement of the cleaning device along a longitudinal extent of the electrode provides erosion protection for the underlying electrode metal, such as tungsten, or another electrode protective coating that may otherwise be eroded or thinned.

In some implementations, opposed cleaning pads are formed of different materials or include different conditioning materials. For example, one pad may bear a felt or mohair cleaning material while the other pad includes a wearable graphite conditioning material.

FIG. 8 is a schematic block diagram illustrating one implementation of an environment in which a cleaning device may operate. An electronic device 900, such as a computer, includes an EFA or EHD air cooling system 920. Electronic device 900 comprises a housing 916, or case, having a cover 910 that includes a display device 912. A portion of the front surface 921 of housing 916 has been cut away to reveal interior 922. Housing 916 of electronic device 900 may also comprise a top surface (not shown) that supports one or more input devices that may include, for example, a keyboard, touchpad and tracking device. Electronic device 900 further comprises electronic circuit 960 which generates heat in operation. A thermal management solution comprises a heat pipe 944 that draws heat from electronic circuit 960 to heat sink device 942.

Device 920 is powered by high voltage power supply 930 and is positioned proximate to heat sink 942. Electronic device 900 may also comprise many other circuits, depending on its intended use; to simplify illustration of this second implementation. Other components that may occupy interior area 922 of housing 920 have been omitted from FIG. 8.

With continued reference to FIG. 8, in operation, high voltage power supply 930 is operated to create a voltage difference between emitter electrodes and collector electrodes disposed in device 920, generating an ion flow or stream that moves ambient air toward the collector electrodes. The moving air leaves device 920 in the direction of arrow 902, traveling through the protrusions of heat sink 942 and through an exhaust grill or opening (not shown) in the rear surface 918 of housing 916, thereby dissipating heat accumulating in the air above and around heat sink 942. Note that the position of illustrated components, e.g., of power supply 930 relative to device 920 and electronic circuit 960, may vary from that shown in FIG. 8.

A controller 932 is connected to device 920 and may use sensor inputs to determine the state of the air cooling system, e.g., to determine a need for cleaning electrodes. Alternatively, the cleaning may be initiated by controller 932 on a timed or scheduled basis, on a system efficiency measurement basis or by other suitable methods of determining when to clean electrodes. For example, detection of electrode arcing or other electrode performance characteristics may be used to initiate movement of the cleaning device to condition the electrode. Electrode performance may be determined by monitoring voltage levels, current levels, acoustic levels, and the like.

In some implementations, cleaning or other conditioning is performed when the electrode is not in use. Alternatively, cleaning operations may be performed at timed intervals. In some cases, conditioning or cleaning may be initiated by controller 932 based upon one or more of an imposed voltage level, a measured electrical potential, determination of the presence of a level of contamination by optical means, by detection of an event or performance parameter, or other methods indicating a benefit from mechanically cleaning the electrode.

Some implementations of thermal management systems described herein employ EFA or EHD devices to motivate flow of a fluid, typically air, based on acceleration of ions generated as a result of corona discharge. Other implementations may employ other ion generation techniques and will nonetheless be understood in the descriptive context provided herein. Using heat transfer surfaces that may or may not be monolithic or integrated with collector electrodes, heat dissipated by electronics (e.g., microprocessors, graphics units, etc.) and/or other components can be transferred to the fluid flow and exhausted. Typically, when a thermal management system is integrated into an operational environment, heat transfer paths e.g., heat pipes, are provided to transfer heat from where it is dissipated or generated to a location(s) within the enclosure where air flow motivated by an EFA or EHD device(s) flows over heat transfer surfaces.

In some implementations, an EFA or EHD air cooling system or other similar ion action device employing an electrode cleaning system may be integrated in an operational system such as a laptop or desktop computer, a projector or video display device, etc., while other implementations may take the form of subassemblies. Various features may be used with different devices including EFA or EHD devices such as air movers, film separators, film treatment devices, air particulate cleaners, photocopy machines and cooling systems for electronic devices such as computers, laptops and handheld devices. One or more devices includes one of a computing device, projector, copy machine, fax machine, printer, radio, audio or video recording device, audio or video playback device, communications device, charging device, power inverter, light source, medical device, home appliance, power tool, toy, game console, television, and video display device.

While the foregoing represents a description of various implementations of the invention, it is to be understood that the claims below recite the features of the present invention, and that other implementations, not specifically described hereinabove, fall within the scope of the present invention.

What is claimed is:

1. An apparatus comprising:
an electrode susceptible to accumulation of detrimental material during operation thereof; and
a cleaning device including opposing surfaces to frictionally engage the electrode therebetween, wherein the opposing surfaces exhibit at least partially complementary surface contours that, when engaged, laterally distort an otherwise linear longitudinal extent of the electrode under tension, the opposing surfaces subject to wear but maintaining the frictional engagement despite wear depths that exceed a radius of the electrode due at least in part to the at least partially complementary surface contours engaging the electrode under tension.

2. The apparatus of claim 1, wherein the electrode, when energized, contributes to flow of ion current in one of an electrohydrodynamic fluid accelerator and an electrostatic precipitator.

3. The apparatus of claim 1, wherein the cleaning device is adapted to transit over at least a substantial portion of the longitudinal extent of the electrode under tension.

4. The apparatus of claim 1, wherein the position of the cleaning device is generally fixed and the electrode under tension is configured to transit the generally fixed cleaning device.

5. The apparatus of claim 1, wherein the cleaning device surface contours are selected to elastically deform the electrode.

6. The apparatus of claim 5, wherein the electrode is an emitter wire having a radius, and the surface contours are selected such that a ratio of the electrode radius to a minimum contour radius does not exceed the yield strain of the electrode material.

7. The apparatus of claim 5, wherein the surface contours are selected to deform the electrode about multiple axes to break-up brittle silica deposits on the electrode.

8. The apparatus of claim 5, wherein the surface contours are selected to elastically deform the emitter electrode in a first direction during longitudinal travel and the cleaning device is laterally moveable to elastically deform the emitter electrode in a second direction.

9. The apparatus of claim 1, wherein the cleaning device is angularly positioned such that the electrode travels at least partially laterally across a respective cleaning device surface during movement of the cleaning device along a longitudinal extent of the electrode.

10. The apparatus of claim 1, wherein the electrode is energizable to motivate fluid flow along a flow path, the apparatus further comprising heat transfer surfaces along the flow path to dissipate heat from an electronic device.

11. The apparatus of claim 10, wherein at least one of the electrode and the cleaning device is moveable in response to detection of one of a low thermal duty cycle, power-on cycle and a power-off cycle of the electronic device, sparking, voltage levels, current levels, acoustic levels, and detection of performance degradation.

12. The apparatus of claim 10, wherein the electronic device is one of a computing device, computing tablet, projector, copy machine, fax machine, printer, radio, audio or video recording device, audio or video playback device, communications device, charging device, power inverter, light source, heat source, medical device, home appliance, power tool, toy, game console, television, and video display device.

13. An apparatus comprising:
an enclosure;
a thermal management assembly for use in convective cooling of one or more devices within the enclosure, the thermal management assembly defining a flow path for conveyance of air between portions of the enclosure over heat transfer surfaces positioned along the flow path to dissipate heat generated by the one or more devices, the thermal management assembly including an electrohydrodynamic (EHD) fluid accelerator including collector and emitter electrodes energizable to motivate fluid flow along the flow path, wherein at least one of the electrodes is susceptible to accumulation of detrimental material during operation thereof; and
a cleaning device including opposing surfaces defining at least partially complementary surface contours that, when engaged with the at least one electrode, elastically deform an otherwise linear longitudinal extent of the at least one electrode under tension.

14. The apparatus of claim 13, wherein the cleaning device is moveable in response to detection of one of a low thermal duty cycle, power-on cycle and a power-off cycle of the one or more devices, sparking, voltage levels, current levels, acoustic levels, and detection of performance degradation.

15. The apparatus of claim 13, wherein the one or more devices includes one of a computing device, projector, copy machine, fax machine, printer, radio, audio or video recording device, audio or video playback device, communications device, charging device, power inverter, light source, medical device, home appliance, power tool, toy, game console, television, and video display device.

16. A method of removing detrimental material from an electrode, the method comprising:
positioning a cleaning device in frictional engagement with the electrode;
transiting one of the cleaning device and the electrode relative to the other of the cleaning device and the electrode to thereby remove detrimental material accumulated on the electrode,
wherein the cleaning device includes opposing surfaces defining at least partially complementary surface contours that, when engaged with the electrode, elastically deform an otherwise linear longitudinal extent of the electrode under tension; and
elastically deforming the electrode to break up detrimental material accumulated on the electrode.

17. The method of claim 16, wherein the opposing surfaces are subject to wear from repeated transiting cycles, the method further comprising maintaining the frictional engagement despite wear depths that exceed a radius of the electrode due at least in part to the at least partially complementary surface contours engaging the electrode under tension.

18. The method of claim 16, further comprising depositing a conditioning material on the electrode in situ via transiting of the one of the cleaning device and the electrode.

19. The method of claim 18, wherein the conditioning material is depositable via the cleaning device.

20. The method of claim 16, wherein the electrode is one of an emitter electrode and a collector electrode.

21. The method of claim 16, wherein the transiting is performed in response to detection of one of a low thermal duty cycle, power-on cycle and a power-off cycle of an electronic device, sparking, voltage levels, current levels, acoustic levels, and detection of performance degradation.

22. The method of claim 16, wherein the cleaning device is wearable to form a sacrificial coating selected to mitigate electrode oxidation or to reduce ozone.

23. The method of claim 16, wherein the electrode is elastically deformed in at least two substantially orthogonal directions.

24. The method of claim 16, further comprising laterally displacing the electrode via lateral movement of the cleaning device relative to a longitudinal extent of the electrode.

25. The method of claim 16, further comprising positioning the cleaning device such that the electrode travels at least partially laterally across a respective cleaning device surface.
